(19) United States
(12) Patent Application Publication
(10) Pub. No.: US 2022/0347699 A1
(43) Pub. Date: Nov. 3, 2022

(54) Ultracompact Centrifuge, Specimen Container, and Methods of Use

(71) Applicant: Laboratory Corporation of America Holdings, Burlington, NC (US)

(72) Inventors: Ulrich Schaff, Livermore, CA (US); Kyungjin Hong, Livermore, CA (US); Tifany Pan, Walnut Creek, CA (US); Jason Ragar, Bay Point, CA (US); Shelby Richmond, Dublin, CA (US); Greg Sommer, Maple Grove, MN (US); Sean Hong, Livermore, CA (US)

(21) Appl. No.: 17/729,761

(22) Filed: Apr. 26, 2022

Related U.S. Application Data
(60) Provisional application No. 63/182,663, filed on Apr. 30, 2021.

(51) Int. Cl. B04B 5/04; B04B 13/00; B04B 7/02; B04B 9/10; B04B 9/14; B01L 3/00

(52) U.S. Cl. CPC B04B 5/0414; B04B 13/00; B04B 7/02; B04B 9/10; B04B 9/14; B01L 3/5021; B01L 2400/0409; B01L 2300/0832; B01L 2300/0858; B01L 2300/04; B01L 2200/0689

(57) ABSTRACT

A portable motorized centrifugal system is optimized for low cost manufacture and operation. Separation of inhomogeneous fluid biological samples, such as liquid plasma from whole blood, is a common step in medical diagnostic tests. This system may enable remote separation where access to plug-in power sources are limited. The system may facilitate at-home testing. Due to biohazard concerns, the entire centrifugal apparatus portable and disposable, or the system includes one or more disposable elements within the interior of the centrifuge. Alternatively, the system may contain a module of higher value components that are re-usable after disinfection. Devices and methods for implementing centrifugal separation may include disk-shaped fluidic cartridges and tubes with reduced drag cross-section.

### REFERENCE TO RELATED APPLICATION

This application claims the benefit of U.S. Provisional Patent Application No. 63/182,663, filed on Apr. 30, 2021 and entitled ULTRACOMPACT CENTRIFUGE, SPECIMEN CONTAINER AND METHODS OF USE, the content of which is hereby incorporated by reference in its entirety.

### FIELD OF THE INVENTION

This invention relates to fluidic separation of particles suspended in a liquid supernatant. In particular, separation of whole blood into plasma and blood cell components, using a centrifugal system. Other biological samples containing cells or particulates may also be separated by such a centrifugal system.

### BACKGROUND OF THE INVENTION

Typically, blood or other similar biological samples should be tested immediately or within four hours of centrifugation, depending on which analyte is being studied. Current processes often result in shipment at the end of a business day with a batch of samples collected throughout the day in a meticulously assembled package. This process decreases the quality of samples taken earlier in the day and increases the opportunity for human error.

### SUMMARY

Described are various embodiments of a portable centrifugation device comprising a rotor, a motor, a set of batteries, a housing, and a lid, and methods of using such embodiments to separate whole blood into plasma or serum and blood cells. It is of note that any fluid sample initially comprising a mixture of a light fraction and a heavy fraction may be similarly separated. The rotor may have an axis of rotation, and may be configured to rotate in a direction of rotation.

Embodiments described herein may include low-cost materials. For example, the housing may include a packaging material. The portable centrifugation device may be capable of being used as a sealed shipping container. The portable centrifugation device may meet shipping regulations for biological samples. For example, the centrifugation device may further comprise a liquid absorbent material, and the housing and the lid may form an airtight cavity when mated. The centrifugation device optionally may lack certain features of a conventional centrifuge such as a circuit board or buttons or hard materials in the housing. The centrifugation device may include an on-board power source such that the device is powered by such a power source. The power source may include, but is not limited to a single cell battery. As a non-limiting example, the centrifugation device may be powered by a single AAA battery.

In certain embodiments, the rotor may include a hollow disk-shape cartridge with a closed circumference configured to contain whole blood and/or other fluid samples. The axis of rotation may be centered within the disk-shaped cartridge. The disk-shaped cartridge may comprise a ring-shaped distal cavity, a central cavity configured to accept whole blood and to retain plasma or serum after separation, and a narrow separation channel positioned between the distal cavity and the central cavity. Embodiments of this invention are configured to separate between 10 and 5000 microliters of blood. The invention may also be configured to separate between 20 and 750 microliters of blood. Preferably, the invention may be configured to separate between 50 and 500 microliters of blood.

In various embodiments, the rotor may include a structure configured to hold one or more tubes. The rotor may have an axis of rotation. Preferably, the rotor may be configured to hold only one tube. The rotor configured to hold only one tube may further comprise a counterweight. The counterweight may be configured such that a combined apparatus comprising the one tube and the rotor has a centroid close to the axis of rotation, when the one tube is filled with a volume of the sample. For example, the centroid could be less than 2 mm from the axis of rotation. The counterweight may further be aerodynamically shaped. For example, a cross-section of the counterweight may present a smooth, wedge shaped, or tear-drop profile in the direction of rotation.

Various other benefits and advantages may be realized with the systems and methods provided herein, and the aforementioned advantages should not be considered limiting.

### BRIEF DESCRIPTION OF THE DRAWINGS

The specification makes reference to the following appended figures, in which use of like reference numerals in different figures is intended to illustrate like or analogous components.

FIG. 1 is a sectional view of an aerodynamic tube assembly according to embodiments.

FIG. 2A is a top view of a tube of the tube assembly of FIG. 1.

FIG. 2B is a sectional view of the tube of FIG. 2A taken along axis A-A in FIG. 2A.

FIG. 2C is a sectional view of the tube of FIG. 2A taken along axis B-B in FIG. 2A.

FIG. 3 is a top view of another tube for an aerodynamic tube assembly according to embodiments.

FIG. 4 is a side view of a centrifuge with a one-tube rotor and the aerodynamic tube of FIG. 1 according to embodiments.

FIG. 5 is a top view of the centrifuge of FIG. 4.

FIG. 6 is a sectional view of the centrifuge of FIG. 4 without a rotor according to embodiments.

FIG. 7 is a top view of another tube for an aerodynamic tube assembly according to embodiments.

FIG. 8 shows a top view of a centrifuge with a detachable lid but without a rotor according to embodiments.

FIG. 9 is a sectional view of the centrifuge of FIG. 8 taken along line C-C in FIG. 8.

FIG. 10 is a side view of an aerodynamic tube assembly according to embodiments.

FIG. 11 is a top view of a tube of the aerodynamic tube assembly of FIG. 10.

FIG. 12 is a side view of a stopper of the aerodynamic tube assembly of FIG. 10.

### BRIEF DESCRIPTION

The embodiments described herein may allow for shipment of biological samples for diagnostic testing by incorporating the regulatory shipping requirements for potentially biohazardous materials as part of the processing and separation devices themselves, which may comprise inexpensive parts. The benefits of a portable or ready-to-ship centrifuge include little to no shipment processing time, optimal diagnostics testing intervals for each sample, and more accurate results for patients. The systems described herein may be compatible with various liquids as desired, including but not limited to whole blood, urine, and/or a collection of non-fluidic cells, such as cell culture or organ cells, that become liquefied in solution.

By enabling shipment of liquid samples, the concentration of the target analyte may be sufficient to undergo canonical assays for detection and quantification. Although dried samples require less of a biological sample to be extracted, for example a dried blood spot, the concentration of an analyte of interest may be too low for precise detection. In addition, dried blood spots require elution through several hours of soaking in a solute particular to each individual analyte. As a result, compatible devices that might be utilized for diagnostic testing following centrifugation are typically designed for liquid samples. Most commonly, biological liquid samples may include whole blood or urine. It is also possible that some biological mixtures start as a collection of non-fluidic cells, such as cell culture or organ cells, and become liquefied in solution. These types of liquids may also be compatible with the invention.

Whole blood quickly deteriorates ex vivo, so it is typically processed within 24 hours of obtaining a sample. Separating whole blood may isolate red blood cells, platelets, and plasma. Plasma has a shelf life of up to 1 year when frozen and can be tested through a comprehensive metabolic panel or lipid panel to determine attributes of a person's overall health. Another benefit of separating whole blood into a plasma part and cell part is that it prevents diagnostic instrument clogging with blood cells. Plasma is more stable than whole blood because red blood cells within the whole blood may hemolyze and release their intracellular contents into the sample, which may interfere with analyte concentrations in diagnostic testing. Serum, the liquid left behind following the clotting of whole blood, may also undergo centrifugation with this invention, but sample processing may be delayed due to the time it takes for whole blood to clot before separation.

The invention, which is powered by an on-board power source such as one or more batteries, enables remote blood separation, especially where access to power-hungry plug-in centrifugation is limited. Without requiring an external power source, use in remote environments or emergency vehicles can be achieved. Although unpowered centrifuges, such as hand-crank operated spinners, exist, a powered centrifuge according to the embodiments described herein provide a consistent spin rate and spin time performance required by regulations and standards for diagnostic testing. Furthermore, balancing and operating a conventional centrifuge is not within the capability of most untrained users as may be common in remote or home environments. At-home testing may be facilitated by ease of use of a small, portable centrifuge that is completely or partially disposable to prevent biohazardous waste in a home where proper disposal systems are not arranged. Complete autonomous use by a user at home is therefore possible.

The inventions described herein are generally intended to facilitate separation and processing of small fluid samples in circumstances where conventional centrifuges are often insufficient or unavailable including, but not limited to: (a) processing samples between 0.02 mL and 1.00 mL in volume, (b) processing samples by untrained users, (c) processing samples in remote areas and/or without available power, (d) processing samples with limited shelf or storage space, and (e) processing samples under time pressure.

### DETAILED DESCRIPTION

Embodiments of the inventions described herein are intended for portable centrifugation of biological samples. Embodiments may be referred to as centrifuges or centrifugal devices. In various embodiments, the centrifuges may be made from low cost and/or disposable materials. The centrifuges may be considered disposable medical devices, suitable for remote deployment. Certain embodiments may be suitable for use as both a centrifuge and as secondary packaging for shipment of biological materials.

In some embodiments, centrifuges described herein may be devices less than 75 mm in diameter. The centrifuges may include a motor, such as a small DC motor, a power source, such as one or more battery cells, and a housing. The housing optionally may include a closeable or removable and attachable lid. Optionally a printed circuit board or other suitable controller controlling the flow of current from the batteries to the motor may be included. When mated with a rotor, the centrifuge may rotate the rotor at between 2000 and 20000 RPM. Preferably, the centrifuge may rotate the rotor between 2000 and 15000 RPM. Rapid separation of blood may be achieved with rotation between 6000 and 15000 RPM.

In some embodiments, the centrifuge may be configured to automatically spin when the closable lid is shut. This may be achieved by way of a sensor, mechanical switch, or magnetic switch such as a reed switch. Other activation mechanisms or devices may be utilized as desired. In certain embodiments, the lid may irreversibly attach to the housing when closed, such as with a pressure sensitive adhesive or a ratchet mechanism. Alternately, attachment of the lid may close a circuit allowing electrical current to flow through the battery and motor.

In certain embodiments, the rotor may include a hollow disk-shaped cartridge. In some embodiments, the cartridge may have a diameter of between 10 mm and 160 mm. Preferably, the diameter of the disk-shaped cartridge may be between 15 mm and 75 mm. More preferably, the disk-shaped cartridge may be between 20 mm and 45 mm. The disc-shaped cartridge may be configured to receive blood, separate blood cells into its periphery following rotation, and separate retrievable plasma into its center.

The housing of the centrifuge may be built from disposable material such as, but not limited to, cardboard or thermoplastics. Optionally, the housing of the centrifuge may partly comprise packing materials used for shipment. The housing of the centrifuge optionally may include multiple layers of materials, such as but not limited to a liquid impermeable layer, a liquid absorbent layer, and an outer layer suitable for shipping directly by postal or courier services. The layers of material may be laminated together by adhesives or otherwise assembled as desired.

The centrifuge motor may be a DC motor. The power source may be various types of batteries. As non-limiting examples, the battery may be a disposable button cell battery or use an AAA or AA configuration. The battery may have a lithium manganese dioxide, zinc carbon, lithium ion, or alkaline chemistry. Optionally, the centrifuge may not include a printed circuit board. The centrifuge may close an electrical circuit upon closure of the lid by an operator. The centrifuge optionally may rotate until the battery is exhausted. The centrifuge may rotate for 5 seconds to 60 minutes. The centrifuge may preferably rotate for 10 seconds to 30 minutes. The centrifuge may rotate for 15 seconds to 3 minutes. In some embodiments, the centrifuge may rotate for 15 seconds to 60 seconds. Timing of the centrifugal spin may depend on the operator such that the spin is initiated when a centrifuge lid is closed and the spin may stop when the centrifuge lid is opened.

The centrifuge may have a disposable inner lining made from materials including but not limited to a layer of plastic or cardboard. The centrifuge may have a re-usable module component comprising the motor, the batteries, and a printed circuit board. The re-usable module may have a smooth and continuous outer surface suitable for disinfection. The circuit board may control the speed of the centrifuge and may count the number of runs. The circuit board may present a visible signal such as by an LED when the centrifuge has reached a maximum number of runs. The circuit board may present a visible signal if the battery reaches a minimum threshold of voltage. The centrifuge may comprise a layer of material affixed to the housing between the motor and the rotor.

The centrifuge housing may include a box made from cardboard or other materials as desired. The lid of the centrifuge housing may contain a magnet and the printed circuit board may contain a magnetic sensor such as a Hall Effect sensor. The printed circuit board may be mounted to the wall of the housing and oriented with a sensor toward a point of interface with the housing lid. The printed circuit board may be mounted to a cardboard wall by a rivet, staple, pressure sensitive adhesive, or glue.

Inner layers of the centrifuge housing may be a hollow cylindrical shape with threading around the top and the motor, and batteries inside. A cylindrical centrifuge housing may comprise metal or plastic. The lid may be circular and contain threading that interfaces with threading on the centrifuge housing. Screwing on the lid may result in completing a circuit from the battery, through the motor, and through an electrical pathway joined to the centrifuge housing and lid. Screwing on the lid may be irreversible or reversible only by squeezing portions of the lid, similar to common pharmaceutical packaging. Alternately, the centrifuge may be roughly square shaped, with a lid that opens and closes by a hinge on one side of the lid. The entire centrifuge and packaging maybe less than 100 mm in length, width, and depth. The entire centrifuge and packaging may be less than 75 mm in length, width, and depth. The centrifuge may be about 2.5 inches in length and width, and less than 2 inches in depth. In some embodiments, the centrifuge packaging may be less than 50 mm in length, width, and depth. The centrifuge may be configured for shipment by commercial methods while meeting relevant packaging standards for potentially biohazardous biological specimens.

### Aerodynamic Tube Assembly

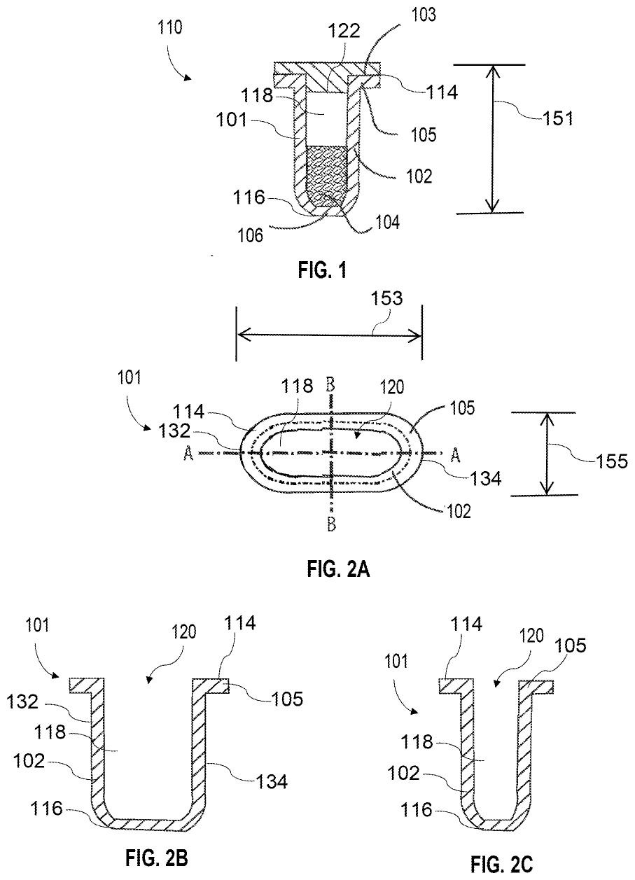

FIGS. 1 and 2A-C illustrate an aerodynamic tube assembly 110 according to various embodiments. The aerodynamic tube assembly 110 includes a tube 101 and a stopper 103. The aerodynamic tube 101 includes a tube wall 102 having a top side 114 and a bottom side 116 and defining a chamber or cavity 118 for receiving a fluid 104 or other material.

The top side 114 defines an opening 120 providing access to the cavity 118 (see, e.g., FIG. 2A). A flange or rim 105 may extend outwards from the tube wall 102 at the top side 114. In certain embodiments, the rim 105 may contact the stopper 103 when the stopper 103 is assembled with the tube 101. In various embodiments, the stopper 103 includes an insert portion 122 that is at least partially positioned within the cavity 118 when the stopper 103 is assembled with the tube 101. Contact between the stopper 103 and the tube 101 (e.g. at the rim 105 and/or within the cavity 118) may optionally seal the cavity 118.

In various embodiments, the bottom side 116 may include a flat or planar surface 106. In such embodiments, the flat surface 106 may allow for the tube 101 and/or the tube assembly 110 to be self-standing, and the tube 101 and/or the tube assembly 110 may be able to stand upright independently.

In certain embodiments, and as best illustrated in FIGS. 2A-C, the tube 101 may be elongated perpendicular to a direction from the top side 114 to the bottom side 116, or the height of the tube 101. In the embodiment illustrated, the tube 101 is elongated along the axis A-A, and the tube 101 thereby generally includes a first edge 132 and a second edge 134. In such embodiments, the cavity 118 has a width 153 along axis A-A (see FIG. 2B) that is greater compared to a width 155 along axis B-B (see FIG. 2C). In the embodiment illustrated, the tube 101 has a generally elliptical shape; however, in other embodiments, and as discussed in detail below, the tube 101 may have other elongated shapes as desired. In various embodiments, and as discussed in detail below, the tube 101 may be configured to rotate such that the tube 101 is elongated in the direction of rotation.

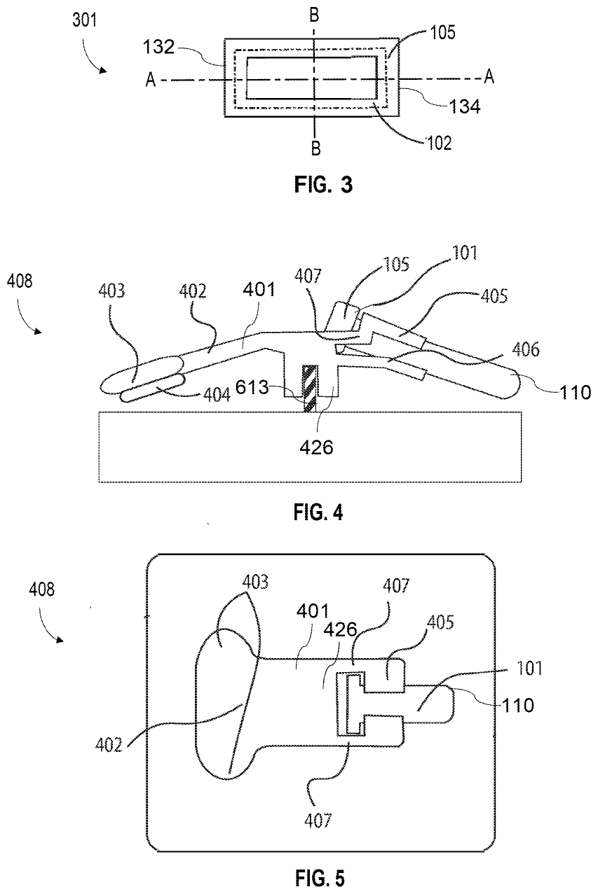

FIG. 3 illustrates another example of an aerodynamic tube 301 that is substantially similar to the tube 101 except that it has a rectangular shape.

FIG. 7 illustrates another example of an aerodynamic tube 701 according to embodiments. Similar to the tube 101, the aerodynamic tube 101 is elongated; however, compared to tube 101, the tube 701 is asymmetrical about the axis B-B. In the embodiment illustrated, the aerodynamic tube 701 a leading edge 709 and a lagging edge 702. Said leading edge 709 may be presented to airflow, and said lagging edge 702 may allow air to pass over aerodynamically. In one non-limiting example, the cross-section may be the shape of an aerofoil where the lagging edge is extended by at least 1.5 times the semi-minor axis of the tube and serves to prevent detachment of streamlines during rotation. However, in other embodiments, the aerofoil-type tube 701 may have leading edges and/or lagging edges with other shapes or profiles as desired.

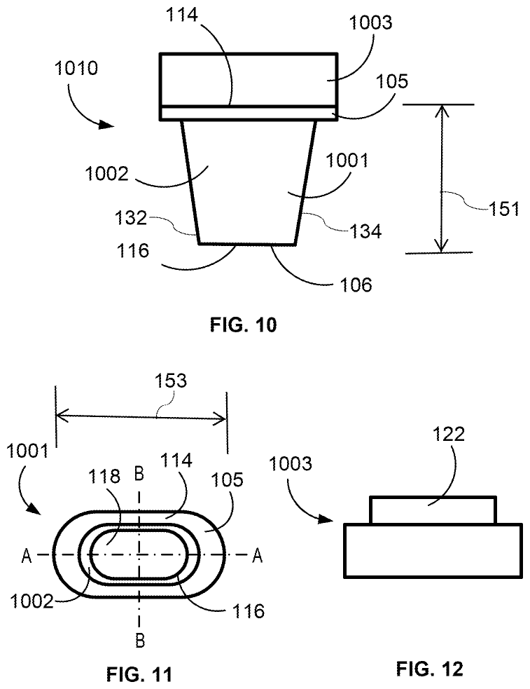

FIGS. 10-12 illustrate another example of an aerodynamic tube assembly 1010 according to various embodiments. The aerodynamic tube assembly 1010 is substantially similar to the aerodynamic tube assembly 110 and includes a tube 1001 and a stopper 1003. However, compared to the tube 101, the tube 1001 is tapered from the top side 114 to the bottom side 116, and a width of the bottom side 116 along the axis A-A is less than a width of the top side 114 along the axis A-A as illustrated in FIG. 11. In certain embodiments, the tube 1001 with the tapered profile may be a compact and aerodynamic cross-section that enables faster and/or more energy efficient separation compared to the tube 101 (e.g., it may be more aerodynamic and thereby allow for more centrifugation runs for a given battery charge or level). Optionally, the tube 1001 may allow for direct fingerstick collection for blood volumes as low as 200 μL, such as from about 200 μL to about 400 μL. The tapered profile may enable a sufficiently wide opening to allow direct fingerstick collection while retaining a compact overall volume. The tube 1001 with the tapered profile may allow for a smaller footprint packaging. In certain embodiments, the tube 1001 may provide for a shorter separation time during centrifugation, and the narrower profile may allow for improved blood pellet stability and/or improved plasma extraction for small volumes. In certain embodiments, the tube 1001 may provide an improved plasma quality. Optionally, the tube 1001 with the tapered profile allows for the tube 1001 to have a reduced weight and a reduced rotational moment of inertia, which may minimize vibration in the rotor during centrifugation. A total height 151 of the tube may be substantially less than typical for microvolume blood collection tubes. As a non-limiting example, the total height 151 may be from about 15 mm to about 30 mm. In one non-limiting example, the total height 151 may preferably be approximately 20 mm. In certain embodiments, a ratio between the total height 151 and the width 153 of the top side along the axis A-A may be 2:1 or less. In some non-limiting examples, the ratio may be less than 1.5:1, such as about 1:1. A reduced height and a relatively low total height to width ratio enables use with compact centrifuge designs as disclosed herein due to reduced sweep diameter when emplaced in the rotor.

Various other benefits and advantages may be realized with the tube provided herein, and the aforementioned advantages should not be considered limiting. Moreover, one or more of the aforementioned benefits or advantages may be realized with other tubes provided herein.

### Centrifuge

FIGS. 4-6 illustrate an example of a centrifuge 408 according to various embodiments. The centrifuge 408 interfaces with a rotor 401 having by way of a motor hub 613. The motor hub 613 may define an axis of rotation that the centrifuge 408 rotates the rotor 401 about during centrifugation.

Referring to FIGS. 4 and 5, the rotor 401 may support one or more centrifuge containers. In the embodiment illustrated, the rotor 401 is supporting the aerodynamic tube assembly 110 as the centrifuge container. The rotor 401 may a center portion 426 and one or more support locations outwards from the center portion 426. In various embodiments, and as illustrated in FIGS. 4 and 5, the rotor 401 may include a single support location. Each support location includes an upper clasp 405, a lower clasp 406, and arms 407. The lower clasp 406 may extend from the center portion 426, and the arms 407 may connect the upper clasp 405 with the center portion 426. The components of the support location together interface with the tube assembly 110 to position the tube assembly 110 on the rotor 401. In the embodiment illustrated the upper clasp 405 and the lower clasp 406 interface with the rim 105 of aerodynamic tube 101 to position the aerodynamic tube 101 on within rotor 401. In certain embodiments, and as best illustrated in FIG. 4, the upper clasp 405 and/or the lower clasp 406 may overlap and/or otherwise provide interference for the rim 105 in a radial direction (i.e., outwards from the motor hub 613 to maintain the tube assembly 110 on the rotor 401 during centrifugation.

In addition to the clasps 405, 406, the rotor 401 may include a counterweight 402, an extension 403, and a rib 404. In certain embodiments, the rib 404 may optionally extend downwards from the counterweight 402. Optionally, the extensions 403 may define a maximum width of the rotor 401. Said rib 404 and extension 403 may provide an aerodynamic counterweight for said aerodynamic tube 101.

In some embodiments, the rotor 401 may be configured for production using a straight-pull injection mold as follows: the upper clasp and lower clasp may be positioned such that no portion of the upper clasp overlaps with any portion of the lower clasp when viewed from above. The axis B-B of the aerodynamic tube 101 (i.e., the shorter width) may be positioned by the rotor such that it is positioned substantially vertically, thereby presenting a smaller cross-section for drag when rotated. Referring to FIG. 5, the direction of rotation would be aligned with the axis A-A of said aerodynamic tube 101, and the axis B-B of said aerodynamic tube would be presented to airflow (i.e., the tube 101 is supported on the rotor 401 such that it is elongated in the direction of rotation).

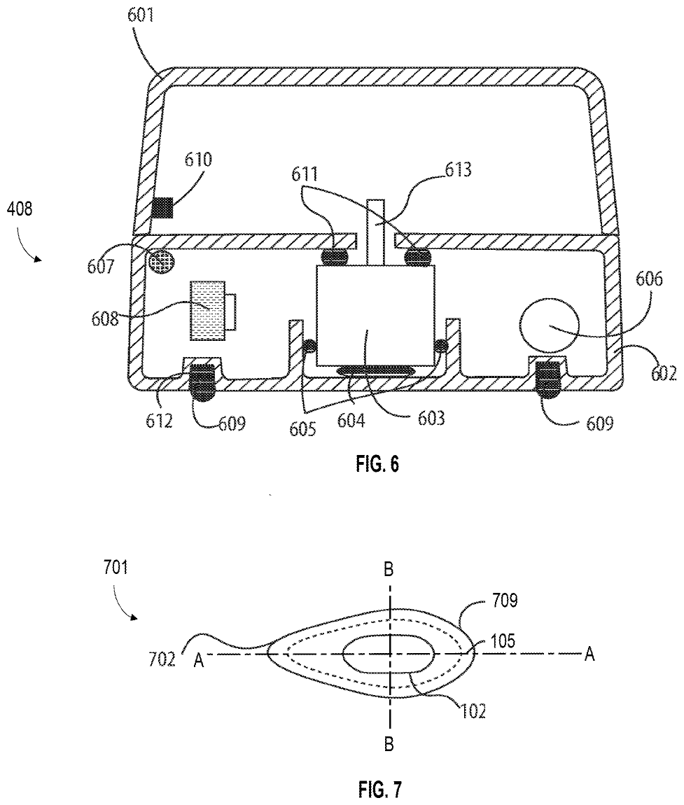

FIG. 6 illustrates the centrifuge 408 in detail and with the rotor 401 removed for clarity of the figure. As illustrated in FIG. 6, the centrifuge 408 includes a centrifuge lid 601 and a centrifuge housing or case 602. The centrifuge lid 601 may interface with a centrifuge case 602 to selectively cover the rotor 401 supported on the motor hub 613.

Said centrifuge case 602 may contain a motor 603. The motor hub 613 on said motor 603 may protrude out of a motor hole, and allow interfacing with said rotor 401. In certain embodiments, the motor 603 is a DC motor; however, other suitable types of motors may be utilized as desired. In various embodiments, the motor 603 interfaces with one or more damping features for vibration damping. In the embodiment illustrated, the motor 603 interfaces with a lower gasket 604, an upper gasket 611 and an O-ring 605 for vibration damping purposes. Said centrifuge case may further include one or more foot recesses 612, which may interface with a corresponding elastic foot 609 for further vibration damping purposes. The foot recess 612 may be approximately as high as the elastic foot 609 in order to minimize the height of the centrifuge 408. As a non-limiting example, the difference in height between the elastic foot 609 and the foot recess 612 may be less than 2 mm. In other embodiments, additional, fewer, and/or various other combinations of damping features may be used as desired

Said centrifuge case 602 may further comprise an on-board power source. In the embodiment illustrated in FIG. 6, the centrifuge case 602 includes one or more batteries 606 as the on-board power source. As non-limiting examples, the battery 606 may be a disposable button cell battery or use an AAA or AA configuration. The battery 606 may have a lithium manganese dioxide, zinc carbon, lithium ion, or alkaline chemistry. The battery 606 within the centrifugal device may not be user changeable; however, in other embodiments, the battery 606 and/or other power source may be changeable and/or chargeable by the user as desired. The on-board power allows for remote centrifugation using the centrifuge 408, especially where access to power-hungry plug-in centrifugation is limited. As a non-limiting example, the on-board power source may allow for use in remote environments or emergency vehicles can be achieved while also providing a consistent spin rate and spin time performance required by regulations and standards for diagnostic testing.

The centrifuge case 602 optionally may include a boost converter 608. The boost converter 608 may be various suitable devices or mechanisms for taking a low input voltage from the battery 606 and yielding a higher output voltage to the motor 603. As a non-limiting example, the low input voltage may be between 0.9 V and 4 V. The higher output voltage may be between 3 V and 15 V. In one embodiment, the low input voltage may be between 0.9 V and 1.7 V and the higher output voltage may be between 3 V and 6 V. The boost converter 608 may comprise a circuit board less than 11 mm in length, width, and depth.

The centrifuge case 602 optionally may further include a magnetic (or other suitable) sensor or switch 607. In such embodiments, the centrifuge lid 601 may comprise a magnet 610, which may interact with said magnetic switch 607, thus completing the circuit and causing said motor 603 to spin. In other words, the magnet 610 and the magnetic switch 607 may allow for the centrifuge 408 to automatically start rotating the rotor 401 upon closing of the lid 601 because the electrical circuit is completed. Optionally, the sensor or switch 607 may be provided on the printed circuit board, although it need not in other embodiments. In one non-limiting example, the switch 607 is a Hall Effect sensor; however, other suitable types of sensors or switches may be utilized as desired. The centrifuge may close an electrical circuit upon closure of the lid by an operator. The centrifuge optionally may rotate until the battery is exhausted. The centrifuge may rotate for 5 seconds to 60 minutes. The centrifuge may preferably rotate for 10 seconds to 30 minutes. The centrifuge may rotate for 15 seconds to 3 minutes. In some embodiments, the centrifuge may rotate for 15 seconds to 60 seconds. Timing of the centrifugal spin may depend on the operator such that the spin is initiated when a centrifuge lid is closed and the spin may stop when the centrifuge lid is opened.

In various embodiments, the centrifuge 408 and/or components of the centrifuge 408 may be disposable, meaning that it may be constructed for a single use after which it is recycled or is disposed of as waste. As a non-limiting example, the centrifuge case 602 and/or lid 601 may be constructed from disposable material such as, but not limited to, cardboard or thermoplastics. Optionally, the case 602 and/or lid 601 of the centrifuge 408 may partly include packing materials used for shipment. The case 602 and/or lid 601 of the centrifuge optionally may include multiple layers of materials, such as but not limited to a liquid impermeable layer, a liquid absorbent layer, and an outer layer suitable for shipping directly by postal or courier services. The layers of material may be laminated together by adhesives or otherwise assembled as desired.

Optionally, the centrifuge 408 may have a re-usable module (e.g., it is partially disposable). As a non-limiting example, the re-usable module may include the motor 603, the batteries 606, and an optional printed circuit board or other controller (processor and/or memory). The re-usable module may have a smooth and continuous outer surface suitable for disinfection.

The circuit board or other controller may control the speed of the centrifuge 408 and may count the number of runs. Optionally, the circuit board may present a signal or alert when the centrifuge 408 has reached a predetermined number of runs. The signal or alert may be various types of signals as alerts as desired, including audible and/or visible signals. As a non-limiting example, the circuit board may provide a visible signal such as by an LED on the centrifuge 408 when the centrifuge 408 has reached a maximum number of runs and/or if the battery 606 reaches a minimum threshold of voltage.

The printed circuit board may be mounted to the wall of the case 602 and oriented with a sensor (e.g., the magnetic (or other) switch 607) having a sensing region toward a point of interface with the lid 601. The printed circuit board may be mounted to a cardboard wall by various suitable mechanical and/or chemical mechanisms as desired, including but not limited to a rivet, staple, pressure sensitive adhesive, and/or glue. In other embodiments, the centrifuge 408 need not include a printed circuit board.

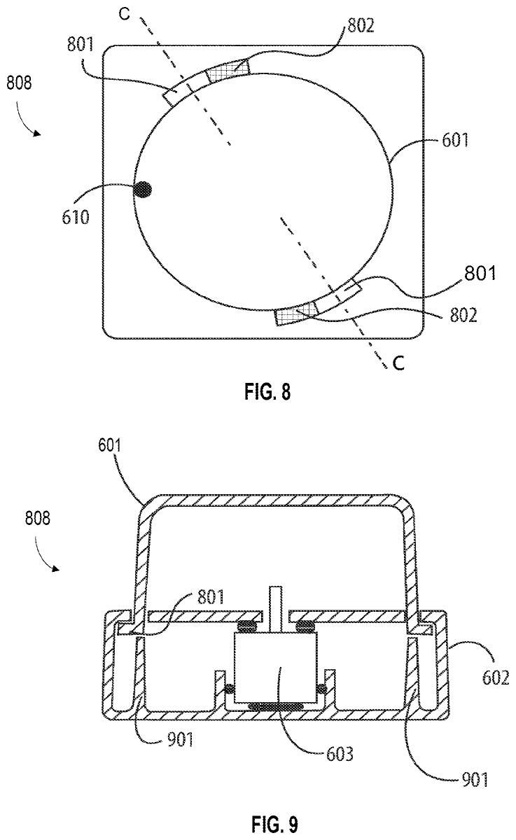

FIGS. 8 and 9 illustrate another example of a centrifuge 808 according to embodiments. Similar to FIG. 6, the rotor is omitted from FIGS. 8 and 9 for clarity of the figure. The centrifuge 808 is substantially similar to the centrifuge 408 except that the lid 601 of the centrifuge 808 is detachable.

As illustrated in FIGS. 8 and 9, in this embodiment, the centrifuge 408 may include a lid tab 801, which will fit within a tab notch 802 defined in the centrifuge case 602. In some embodiments, the tab notch 802 may be a hole, groove, recess, opening, and/or other location defined in the centrifuge case 602. The tab notch 802 may be of equal or greater size to the tab 801. The centrifuge lid 601 may be secured to the centrifuge housing 602 by pressing the lid tab 801 into the tab notch 802, and then twisting the lid into an active position (e.g., counter-clockwise in FIG. 8). A magnet 610 may be put into a position over a magnetic sensor or magnetic switch, and cause said motor 603 to spin when said lid 601 is twisted in a first direction into the active position. After centrifugation is complete, the centrifuge may be deactivated and the lid 601 may be removed from the centrifuge housing 602 by twisting the lid in a direction that is opposite the first direction (e.g., clockwise in FIG. 8) to an open position wherein the tab notch 802 and the lid tab 801 are again aligned.

Optionally, and as illustrated in FIG. 9, the centrifuge case 602 may include a lid rib 901, which may interface with said centrifuge lid 601. The lid rib 901, in combination with the top inner surface of the centrifuge case 602 prevents the lid tab 801 from moving vertically (i.e., the tab 801 is overlapped in a vertical direction by both the lid rib 901 and the case 602, thereby minimizing and/or preventing vertical movement). The centrifuge lid 601 may therefore be secured to the centrifuge case 602 when the lid has been properly twisted into active position. Optionally, the centrifuge lid 601 may be secured to the centrifugal case 602 in an intermediate position between the active position and the open position. The centrifuge may be deactivated such that it does not spin when the centrifuge lid is in the intermediate position.

A collection of exemplary embodiments, including at least some explicitly enumerated as “Illustrations” providing additional description of a variety of example types in accordance with the concepts described herein are provided below. These embodiments are not meant to be mutually exclusive, exhaustive, or restrictive; and the invention is not limited to these example embodiments but rather encompasses all possible modifications and variations within the scope of the issued claims and their equivalents.

Illustration 1. An aerodynamic tube assembly for a centrifuge, the aerodynamic tube assembly comprising an aerodynamic tube, the aerodynamic tube comprising: a tube wall comprising a top side and a bottom side, wherein the tube wall defines a cavity, wherein the tube is elongated in a direction perpendicular to a direction extending from the top side to the bottom side.

Illustration 2. The aerodynamic tube assembly of any preceding or subsequent illustrations or combination of illustrations, wherein the top side comprises a rim extending outwards from the tube wall, and wherein the top side defines an opening to the cavity.

Illustration 3. The aerodynamic tube assembly of any preceding or subsequent illustrations or combination of illustrations, wherein the bottom side of the tube wall comprises a planar surface.

Illustration 4. The aerodynamic tube assembly of any preceding or subsequent illustrations or combination of illustrations, wherein the tube wall is tapered from the top side to the bottom side such that a width of the bottom side in the direction that the tube is elongated is less than a width of the top side in the direction that the tube is elongated.

Illustration 5. The aerodynamic tube assembly of any preceding or subsequent illustrations or combination of illustrations, wherein the tube wall is elongated as an aerofoil comprising a leading edge and a lagging edge, wherein a profile of the leading edge is different from a profile of the lagging edge.

Illustration 6. The aerodynamic tube assembly of any preceding or subsequent illustrations or combination of illustrations, wherein the lagging edge is at least 1.5 times a length of the leading edge.

Illustration 7. The aerodynamic tube assembly of any preceding or subsequent illustrations or combination of illustrations, further comprising a stopper configured to seal the cavity.

Illustration 8. The aerodynamic tube assembly of any preceding or subsequent illustrations or combination of illustrations, wherein the stopper comprises an insertion portion that is at least partially positionable within the cavity of the aerodynamic tube through the top side.

Illustration 9. A rotor for a portable centrifuge, the rotor comprising: a center portion configured to engage a motor hub of the portable centrifuge; a support location for an aerodynamic tube having a height and that is elongated in a direction perpendicular to the height of the aerodynamic tube, the support location comprising: a lower clasp extending outwards from the center portion; arms extending outwards from the center portion; and an upper clasp on the arms, wherein the lower claps and the upper clasp are configured to interface with a rim of the aerodynamic tube.

Illustration 10. The rotor of any preceding or subsequent illustrations or combination of illustrations, wherein the upper clasp and the lower clasp do not overlap in a vertical direction.

Illustration 11. The rotor of any preceding or subsequent illustrations or combination of illustrations, further comprising a counterweight extending outwards from the center portion in a direction opposite from the support location.

Illustration 12. The rotor of any preceding or subsequent illustrations or combination of illustrations, wherein the counterweight comprises a rib extending downwards from the counterweight and extensions extending outwards from the counterweight in a direction of rotation.

Illustration 13. The rotor of any preceding or subsequent illustrations or combination of illustrations, wherein the extensions define a maximum width of the rotor.

Illustration 14. A portable centrifuge comprising: a housing comprising a centrifuge case and a centrifuge lid configured to interface with the centrifuge case, wherein the housing comprises a single-use material; a centrifuge case comprising: a motor within the centrifuge case for interfacing with and rotating a rotor; a damping system with the centrifuge case; and an on-board power source within the centrifuge case; and an activation system for activating the motor based on an interfacing of the centrifuge lid with the centrifuge case.

Illustration 15. The portable centrifuge of any preceding or subsequent illustrations or combination of illustrations, wherein the activation system comprises a magnet on the centrifuge lid and magnetic switch within the centrifuge housing and connected to the on-board power source and the motor.

Illustration 16. The portable centrifuge of any preceding or subsequent illustrations or combination of illustrations, wherein the damping system comprises an upper gasket, a lower gasket, and an O-ring.

Illustration 17. The portable centrifuge of any preceding or subsequent illustrations or combination of illustrations, wherein the motor is a DC motor, and wherein the portable centrifuge further comprises a boost converter for receiving an input voltage from the on-board power source and yielding an output voltage to the DC motor.

Illustration 18. The portable centrifuge of any preceding or subsequent illustrations or combination of illustrations, further comprising a controller configured to: control a speed of the centrifuge; count a number of runs by the centrifuge; and generate an alert based on the portable centrifuge being in a predetermined condition, wherein the predetermined condition comprises at least one of a maximum number of runs or a minimum threshold of voltage of the on-board power source.

Illustration 19. The portable centrifuge of any preceding or subsequent illustrations or combination of illustrations, wherein the on-board power source comprises at least one battery.

Illustration 20. The portable centrifuge of any preceding or subsequent illustrations or combination of illustrations, wherein: the centrifuge lid comprises a lid tab; and the centrifuge case comprises: a tab notch defined in the centrifuge case and configured to receive the lid tab; and a lid rib, wherein centrifuge case and the lid rib are configured to vertically overlap the lid tab based on rotation of the centrifuge lid relative to the centrifuge case.

Descriptions, scenarios, examples and drawings are non-limiting embodiments. All references to “invention” refer to “embodiments.” Embodiments described herein are of a device intended for use in blood separation, and methods of using the device. Other embodiments have other applications. Drawings are not to scale.

Ideal, Ideally, Optimum and Preferred—Use of the words, “ideal,” “ideally,” “optimum,” “optimum,” “should” and “preferred,” when used in the context of describing this invention, refer specifically to a best mode for one or more embodiments for one or more applications of this invention. Such best modes are non-limiting, and may not be the best mode for all embodiments, applications, or implementation technologies, as one trained in the art will appreciate.

All examples are sample embodiments. In particular, the phrase “invention” should be interpreted under all conditions to mean, “an embodiment of this invention.” Examples, scenarios, and drawings are non-limiting. The only limitations of this invention are in the claims.

May, Could, Option, Mode, Alternative and Feature—Use of the words, “may,” “could,” “option,” “optional,” “mode,” “alternative,” “typical,” “ideal,” and “feature,” when used in the context of describing this invention, refer specifically to various embodiments of this invention. Described benefits refer only to those embodiments that provide that benefit. All descriptions herein are non-limiting, as one trained in the art appreciates. The phrase, “configured to” also means, “adapted to.” The phrase, “a configuration,” means, “an embodiment.”

All numerical ranges in the specification are non-limiting exemplary embodiments only. Brief descriptions of the Figures are non-limiting exemplary embodiments only.

Embodiments of this invention explicitly include all combinations and sub-combinations of all features, elements and limitation of all claims. For avoidance of doubt, any combination of features not physically impossible or expressly identified as non-combinable herein may be within the scope of the invention. Embodiments of this invention explicitly include all combinations and sub-combinations of all features, elements, examples, embodiments, tables, values, ranges, and drawings in the specification, figures, drawings, and all drawing sheets. Embodiments of this invention explicitly include devices and systems to implement any combination of all methods described in the claims, specification and drawings. Embodiments of the methods of invention explicitly include all combinations of dependent method claim steps, in any functional order. Embodiments of the methods of invention explicitly include, when referencing any device claim, a substitution thereof to any and all other device claims, including all combinations of elements in device claims.

That which is claimed:

1. An aerodynamic tube assembly for a centrifuge, the aerodynamic tube assembly comprising an aerodynamic tube, the aerodynamic tube comprising:
a tube wall comprising a top side and a bottom side, wherein the tube wall defines a cavity, wherein the tube is elongated in a direction perpendicular to a direction extending from the top side to the bottom side.

2. The aerodynamic tube assembly of claim 1, wherein the top side comprises a rim extending outwards from the tube wall, and wherein the top side defines an opening to the cavity.

3. The aerodynamic tube assembly of claim 1, wherein the bottom side of the tube wall comprises a planar surface.

4. The aerodynamic tube assembly of claim 1, wherein the tube wall is tapered from the top side to the bottom side such that a width of the bottom side in the direction that the tube is elongated is less than a width of the top side in the direction that the tube is elongated.

5. The aerodynamic tube assembly of claim 1, wherein the tube wall is elongated as an aerofoil comprising a leading edge and a lagging edge, wherein a profile of the leading edge is different from a profile of the lagging edge.

6. The aerodynamic tube assembly of claim 5, wherein the lagging edge is at least 1.5 times a length of the leading edge.

7. The aerodynamic tube assembly of claim 1, further comprising a stopper configured to seal the cavity.

8. The aerodynamic tube assembly of claim 7, wherein the stopper comprises an insertion portion that is at least partially positionable within the cavity of the aerodynamic tube through the top side.

9. The aerodynamic tube assembly of claim 4, wherein a ratio of a total height of the aerodynamic tube to the width of the top side in the direction that the tube is elongated is 2:1 or less.

10. A rotor for a portable centrifuge, the rotor comprising:
a center portion configured to engage a motor hub of the portable centrifuge;
a support location for an aerodynamic tube having a height and that is elongated in a direction perpendicular to the height of the aerodynamic tube, the support location comprising:
a lower clasp extending outwards from the center portion;
arms extending outwards from the center portion; and
an upper clasp on the arms,
wherein the lower claps and the upper clasp are configured to interface with a rim of the aerodynamic tube.

11. The rotor of claim 10, wherein the upper clasp and the lower clasp do not overlap in a vertical direction.

12. The rotor of claim 10, further comprising a counterweight extending outwards from the center portion in a direction opposite from the support location.

13. The rotor of claim 12, wherein the counterweight comprises a rib extending downwards from the counterweight and extensions extending outwards from the counterweight in a direction of rotation.

14. A portable centrifuge comprising:
a housing comprising a centrifuge case and a centrifuge lid configured to interface with the centrifuge case, wherein the housing comprises a single-use material;
a centrifuge case comprising:
a motor within the centrifuge case for interfacing with and rotating a rotor;
a damping system with the centrifuge case; and
an on-board power source within the centrifuge case; and
an activation system for activating the motor based on an interfacing of the centrifuge lid with the centrifuge case.

15. The portable centrifuge of claim 14, wherein the activation system comprises a magnet on the centrifuge lid and magnetic switch within the centrifuge housing and connected to the on-board power source and the motor.

16. The portable centrifuge of claim 14, wherein the damping system comprises an upper gasket, a lower gasket, and an O-ring.

17. The portable centrifuge of claim 14, wherein the motor is a DC motor, and wherein the portable centrifuge further comprises a boost converter for receiving an input voltage from the on-board power source and yielding an output voltage to the DC motor.

18. The portable centrifuge of claim 14, further comprising a controller configured to:
control a speed of the centrifuge;
count a number of runs by the centrifuge; and
generate an alert based on the portable centrifuge being in a predetermined condition, wherein the predetermined condition comprises at least one of a maximum number of runs or a minimum threshold of voltage of the on-board power source.

19. The portable centrifuge of claim 14, wherein the on-board power source comprises at least one battery.

20. The portable centrifuge of claim 14, wherein:
the centrifuge lid comprises a lid tab; and
the centrifuge case comprises:
a tab notch defined in the centrifuge case and configured to receive the lid tab; and
a lid rib,
wherein centrifuge case and the lid rib are configured to vertically overlap the lid tab based on rotation of the centrifuge lid relative to the centrifuge case.
